(19) United States
(12) Patent Application Publication
(10) Pub. No.: US 2004/0212928 A1
(43) Pub. Date: Oct. 28, 2004

(54) Magnetic disk cartridge

(75) Inventors: Fumihito Imai, Odawara-shi (JP); Hideaki Shiga, Odawara-shi (JP); Harumi Aoishi, Odawara-shi (JP); Yasushi Endo, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/845,260

(22) Filed: May 14, 2004

(30) Foreign Application Priority Data
Jun. 30, 2003 (JP) PAT. 187146/2003
Apr. 7, 2003 (JP) PAT. 270996/2003
Mar. 9, 2003 (JP) PAT. 311312/2003

(51) Int. Cl. G11B 23/03

(52) U.S. Cl. 360/133

(57) ABSTRACT

A magnetic disk cartridge which is used with a high density recording magnetic disk and which provides good recording and reproducing properties. The magnetic disk cartridge has a flexible magnetic disk having a disk-like center core. The upper surface of the disk-like center core is centrally affixed to the magnetic disk. The magnetic disk is rotatably retained in a flat housing. The magnetic disk has a surface recording density of at least about 158.7 Mbit/cm2. The disk wobbling value of the magnetic disk measured at a radial position located 5 mm outward from the outer diameter of the center core of the magnetic disk while rotating the magnetic disk by means of a drive device via the center core is not more than 20 μm.

### BACKGROUND OF THE INVENTION

1. Field of the Invention

This invention relates to a disk cartridge having a casing which rotatably holds therein a discoid flexible magnetic disk such as a magnetic disk, and more particularly to a magnetic disk cartridge having a structure in which a magnetic disk is affixed to an upper surface of a center core.

2. Description of the Related Art

Conventionally, mobile equipment such as a digital camera, etc., uses as a recording medium a very small magnetic disk cartridge (see, for example, U.S. Pat. Nos. 6,133,544 and 5,995,346). Such a disk cartridge typically comprises a flat housing (for example, of width 50 mm, depth 55 mm, and thickness 1.95 mm) which rotatably holds therein a flexible magnetic disk of 46.5 mm diameter. The housing is constituted by upper and lower shell halves formed of a thin metal sheet.

The aforementioned magnetic disk may be a disk of flexible thin plastic film having a magnetic layer on both surface thereof. Such a magnetic disk is accommodated within the housing with the center portion of the magnetic disk being affixed to a disk-like center core, for example, made of metal. When this magnetic disk cartridge is loaded in a drive device, an engaging portion disposed on a lower surface of the center core is magnetically attracted to and chucked on the drive spindle of the drive device. The disk drive rotates the center core, which in turn rotates the magnetic disk.

The magnetic disk is affixed onto the upper surface of the center core, for example, by applying an acrylic adhesive to the upper surface of the center core positioned perpendicular to the rotational axis or by applying a double sided adhesive tape, having a backing of plastic film, onto the substantially entire surface of the center core, and subsequently placing the magnetic disk thereon.

In the field of recording and reproducing systems using a flexible magnetic disk as stated above, research on increasing the recording density of the magnetic disk has been done. To this end, it is necessary to achieve higher rotation speed (for example, 3,000 to 8,000 rpm) of the magnetic disk than hitherto. This, however, introduces a new problem that followability of a recording/reproducing head to a servo track signal is impaired even when a slight distortion, which has been substantially negligible heretofore, is present on the magnetic disk, because the variable period is shorten as a result of increasing the rotation speed.

On the other hand, significant efforts have been directed to increase the recording density of the magnetic recording layer of the magnetic disk in order to accommodate increase in data amount (for example, still images and movies) that a user treats. As the recording density increases, however, it becomes difficult to ensure reliable recording/reproducing properties, as a result of which ensuring a desired storage capacity becomes impossible.

Further, downsizing magnetic disk cartridges has also been sought as well as increasing the recording density of magnetic disks. However, the smaller the disk cartridge, the more the deterioration of the recording/reproducing properties, thereby further increasing difficulty to ensure a desired storage capacity.

Accordingly, an object of the invention is to provide a magnetic disk cartridge which uses a magnetic disk that supports high density recording, and which provides good recording and reproducing properties. Another object of the invention is to provide a downsized magnetic disk cartridge which uses a magnetic disk that supports high density recording, and which provides good recording and reproducing properties.

### SUMMARY OF THE INVENTION

Through a devoted investigation for achieving the aforementioned objects, the present inventors have discovered the fact that even a slight disk wobbling value, which has been substantially negligible heretofore, at a radial position located 5 mm outward from the outer diameter of the center hub of the magnetic disk measured while rotating the magnetic disk by means of a drive significantly affects the recording/reproducing with a greater density, and this is one of causes of degradation of the recording/reproducing properties, found that good recording/reproducing properties can be provided by controlling the disk wobbling to fall within a given range, and resulted in the present invention. Specifically, the present invention provides a magnetic disk cartridge comprising: a flexible magnetic disk having a disk-like center core, the upper surface of the disk-like center core being centrally affixed to the magnetic disk; and a flat housing for rotatably holding therein the magnetic disks, wherein the magnetic disk has a surface recording density at least about 158.7 Mbit/cm², and wherein the disk wobbling value of the magnetic disk measured at a radial position disposed 5 mm outward from the outer diameter of the center core of the magnetic disk while rotating the magnetic disk by means of a drive device via the center core is not more than 20 μm

As used herein, the term “wobbling value” means a difference between the maximum displacement and minimum displacement from the reference surface of a surface of a magnetic disk affixed to a center core when measured in the direction of the rotation axis at the aforementioned radial position while rotating the magnetic disk by means of the drive device.

According to the invention, the aforementioned disk wobbling value is preferably not more than 15 μm, more preferably not more than 12 μm. The magnetic cartridge having a wobbling value within a range of values below the aforementioned wobbling values can be easily manufactured by incorporating one or more of the following features:

1. An upper surface of the center core is centrally affixed to the magnetic disk via a double sided adhesive tape. 1. This double sided adhesive tape is selected from those having an average thickness ranging from 10 μm to 160 μm, preferably from 10 μm to 50 μm, and more preferably 10 μm to 35 μm.

2. The center core and the magnetic disk are affixed to each other via a double sided adhesive tape having a structure in which adhesive layers are formed on respective opposite sides of a film backing such as of polyester film. In this case, each adhesive layer on a film backing is preferably in the range of 4 μm to 50 μm.

3. The doubles sided adhesive tape mentioned above is selected from those having a thickness whose deviation from its average thickness is within 10%.

4. Flatness of the magnetic disk surface when measured along the radially outermost peripheral edge of the region of the magnetic disk which is affixed to the disk-like center core is not more than 30 μm, preferably not more than 20 μm, and more preferably not more than to 10 μm.

The term “flatness” in this context means a difference between the maximum displacement and minimum displacement from the reference surface measured in the direction of the rotation axis of the magnetic disk. In order to control the flatness of the adhesion region in the range given above, for example, following approaches are used alone or in combination: flattening a magnetic disk; flattening an adhesive member for affixing a magnetic disk to a center core; flattening a surface of the center core onto which a magnetic disk is affixed; and providing a step of eliminating a disk distortion after affixing the magnetic disk onto the disk core during a disk cartridge manufacturing process.

According to the magnetic disk cartridge of the invention, even when the magnetic disk has a surface recording density of not less than about 158.7 Mbit/cm², good recording/reproducing properties can be ensured because the wobbling value at a radial position located 5 mm outward from the outer diameter of the center hub of the magnetic disk is controlled to a value that is significantly less than hitherto.

Further, by providing a flatness not more than 30 μm at the region, which is affixed to the center core, of the magnetic disk, the degradation in recording/reproducing properties caused by disk distortion can be prevented even when the magnetic disk cartridge is reduced in size and therefore the adhesion region and data recording region of the magnetic disk are located closer to each other.

### BRIEF DESCRIPTION OF THE DRAWINGS

FIG. 1A is a plan view and FIG. 1B is a bottom view, showing a magnetic disk cartridge according to one embodiment of the invention;

FIG. 2 is an enlarged sectional view showing essential parts of the magnetic disk cartridge taken along line II-II in FIG. 1B;

FIGS. 3A and 3B are enlarged sectional views schematically showing a configuration of a magnetic disk cartridge before (3A) and after (3B) when a disk core is affixed to a disk adhesion surface of a center core via a double-sided adhesive tape; and

FIG. 4 is an enlarged sectional view schematically showing a configuration of a magnetic disk cartridge when a disk core is affixed to a disk adhesion surface of a center core via a double-sided adhesive tape.

### DESCRIPTION OF THE PREFERRED EMBODIMENTS

Hereinafter, a disk cartridge according to an embodiment of the invention will be described in detail with reference to the drawings.

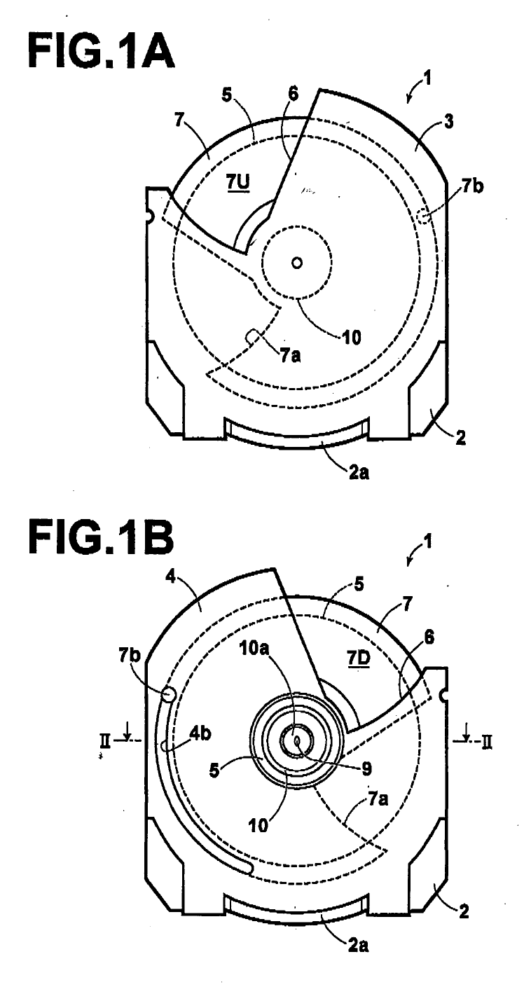

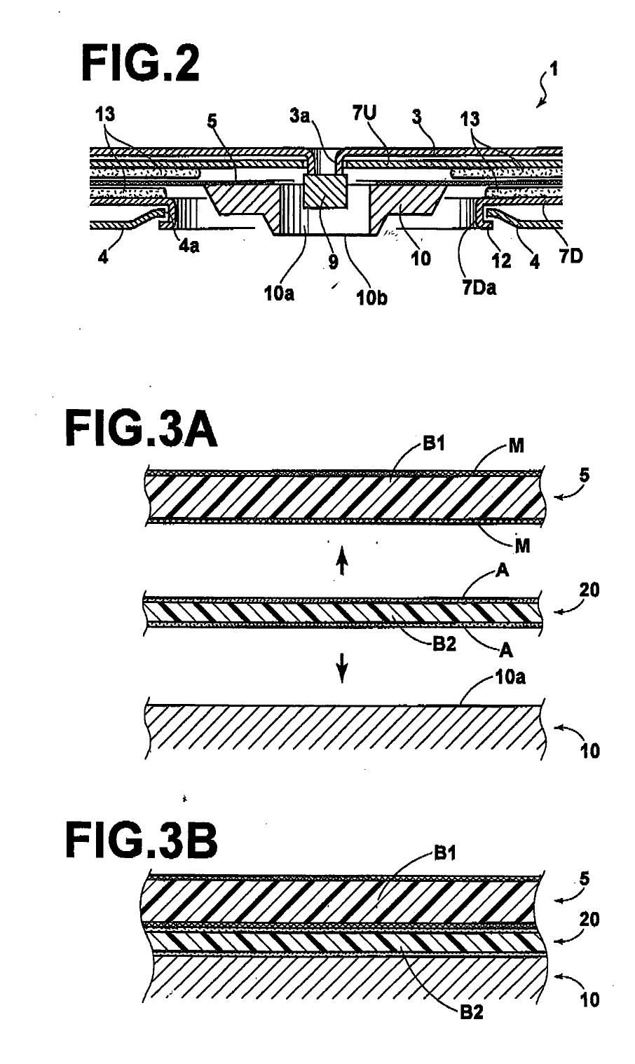

FIG. 1A is a plan view and FIG. 1B is a bottom view, showing a magnetic disk cartridge to which the present invention is applied, and FIG. 2 is an enlarged sectional view. showing essential parts of the magnetic disk cartridge taken along line II-II in FIG. 1B.

This disk cartridge 1 comprises a flat housing (width 50 mm, depth 55 mm, thickness 1.95 mm) constituted by a resin frame 2 (which is also called a spacer or stabilizer) including a push portion 2a, and upper and lower shells 3 and 4 formed of a thin metal sheet of 0.2 mm thick; and a magnetic disk 5 which is 46.5 mm diameter magnetic disk having a 1 GB storage capacity. The magnetic disk 5 is accommodated in the flat housing such that it becomes rotatable when the disk cartridge 1 is mounted in the drive device. A center core 10 having a central aperture 10a is fixedly attached to the central portion of the magnetic disk 5.

The magnetic disk cartridge 1 is intended to be loaded in a TYPE II PC card type drive device (width 53 mm, depth 85 mm, thickness 5 mm, not shown) through a slot thereof in an inserted manner. Each of the upper and lower shells 3 and 4 is provided with a wedge-shaped opening 6 to allow a recording/reproducing magnetic head of the disk drive to access the surface of the magnetic disk 5. A rotary shutter 7, which has an opening 7a is provided for pivotally opening and closing the opening 6, is disposed within each of the upper and lower shells 3 and 4, and urged towards its closing direction by means of a spring member (not shown).

The rotary shutter 7 is constituted by upper and lower shutter members 7U and 7D which are engaged with each other at the peripheries thereof. As is apparent from FIG. 2, the upper shutter member 7U is rotatably supported by a small-diameter cylinder 3a of the upper shell 3. The cylinder 3a projects inwardly from the lower surface of the upper shell 3. A retaining member 9 (called a center pin) is welded to the extremity of the cylinder 3a in order to prevent the upper shutter member 7U from falling off from the cylinder 3a. The retaining member 9 is inserted in the central aperture 10a of the center core 10.

The lower shell 4 has a center hole 4a for exposing the center core 10 towards the outside. A large diameter cylinder 7Da extending downwardly is provided at the central portion of the lower shutter member 7D and loosely engaged with the edge of the center hole 4a of the lower shell 4. The lower shell 4 rotatably supports the lower shutter member 7D via this large diameter cylinder 7Da. The distal end of the cylinder 7Da is caulked to form a flange 12. The flange 12 serves to prevent the lower shutter member 7D from falling off from the lower shell 4. A liner 13 is affixed to the inner surface of each of the upper and lower shutter members 7U and 7D.

The lower shutter shell 4 is also provided with an arcuate groove 4b concentric with the rotary shutter 7. The rotary shutter member 7D has a shutter knob 7b fixedly provided thereon as shown in FIG. 1B. The shutter knob 7b protrudes through the arcuate opening 4b, and travels along this arcuate opening 4b to allow opening and closing of the rotary shutter 7. In association with loading of the magnetic disk cartridge 1 into the drive device, the shutter knob 7b engages with an engaging wall of the drive device, during which the rotary shutter 7 is rotated to its open position aligned with the either opening 6 of the upper and lower shells 3, 4, and consequently the magnetic disk 5 is exposed through the opening of the upper and lower shells 3, 4. On the other hand, in association with unloading of the magnetic disk cartridge 1, the rotary shutter 7 is returned to its closed position shown in FIGS. 1A and 1B by means of a spring member (not shown).

FIGS. 3A and 3B are enlarged sectional views schematically showing configuration of a magnetic disk cartridge before and after a magnetic disk 5 is affixed on a disk adhesion surface 10a of a center core 10 via a double-sided adhesive tape 20.

As shown in FIG. 3A, the magnetic disk 5 comprises a flexible film backing B1 having a thickness of 53 μm formed of PET resin or polyethylene naphthalate (PEN) resin, and magnetic layers M, M layered on either side of the flexible film backing B1. The magnetic layer contains, for example, BaFe as a ferromagnetic powder material. The double sided adhesive tape 20 comprises a flexible film backing B2, and adhesive layers A, A respectively layered on both sides of the flexible film backing 32. After the double-sided adhesive tape 20 is affixed to the magnetic disk 5 via the adhesive layer A disposed on the upper surface of the double-sided adhesive tape, the other adhesive layer A disposed on the lower surface of the tape is affixed to the disk adhesion surface 10a of the center core 10, whereby the magnetic disk 5 is fixedly attached on the disk adhesion surface 10a of the center core 10.

This particular embodiment uses a double sided adhesive tape 20 having a total thickness in a range from 10 μm to 160 μm. The double sided adhesive tape 20 comprises a film backing B2 formed of a polyester resin such as polyethylene naphthalate (PET), polyethylene naphthalate (PEN) or the like; and acrylic resin adhesive layers A, A respectively layered on both side of the flexible film backing B2.

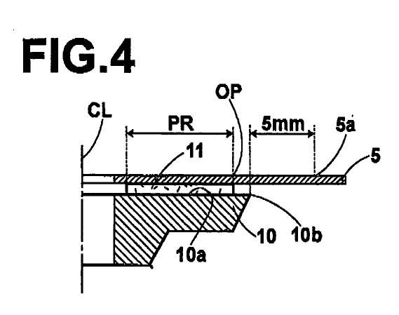

Table 1 shows actual measured values of the disk wobbling under rotation when a magnetic disk 5, which comprises a film backing B2 formed of PET resin of 53 μm thick, was attached onto the disk adhesion surface 10a of the center core 10 using five types of double-sided adhesive tapes 20 which are different each other in thickness. The disk wobbling under rotation of the magnetic disk 5 is measured by means of an ultra-precision laser displacement sensor at a radial position 5a located 5 mm outward from the outer diameter 10b of the center core as shown in FIG. 4.

For actual measurements, seven samples were prepared by affixing magnetic disks respectively to center hubs via seven types of commercially-available double sided adhesive tapes 20: a double sided adhesive tape that comprises a backing of 2 μm thick PET applied with adhesive layers on the opposed sides thereof and has a total thickness of 10 μm; and double sided adhesive tapes that respectively comprise backings of 12 μm thick PET applied with adhesive layers on the opposed sides thereof and respectively have total thicknesses of 30 μm, 48 μm, 80 μm, 125 μm, 160 μm, and 205 μm.

A servo signal is written in each sample. Then each sample is housed in the cartridge shown in FIG. 1 and subjected to measurement of a position error signal (PES). Deviation rate with respect to the track width obtained from the result of measuring PES are shown in percent in Table 1 below. Generally, the track can be followed when the deviation rate is not more than 18%. The deviation rate is preferably not more than 5%, and more preferably not more than 3%. As is apparent from Table 1, a favorable result is obtained when the wobbling value is not more than 20 μm, a more favorable result is obtained when the wobbling value is not more than 15 μm, and a most favorable result is obtained when the wobbling value is not more than 12 μm. As can be seen from Table 1, the measurement results support that when the double-sided adhesive tape of not more than 160 μm thick is used, the disk wobbling under rotation is more reduced than when the double-sided adhesive tape of not less than 205 μm thick is used. Preferable thickness of the adhesive layer A of the double-sided adhesive tape 20 is within the range from 4 μm to 40 μm.

In this particular embodiment, a double-sided adhesive tape 20 having adhesive layers A, A respectively disposed on opposed sides of a flexible film backing B2 was used. In this case, it was found that better results can be obtained when the film backing B2 was formed of polyester resin such as PET or PEN and the adhesive layer was formed of acrylic resin.

Even when the double-sided adhesive tape 20 is constituted by only a single adhesive layer without film backing B2 or constituted by a non-woven fabric backing impregnated with an adhesive, a similar effect as that of the foregoing case could be obtained so long as the variability of thickness with respect to its own average thickness is within 10%.

According to the disk cartridge of the invention, the wobbling value can also be suppressed in the 20 μm or less range by controlling the flatness of the magnetic disk surface when measured along the radially outermost peripheral edge of the region of the magnetic disk which is affixed to the disk-like center core not to exceed 30 μm. This enables to reduce the degradation in recording/reproducing properties caused by the distortion of the magnetic disk at the adhesion region thereof, even if the magnetic disk has a surface recording density of at least about 158.7 Mbit/cm².

In addition, when a flatness of the region, which is adhered to the center core, of the magnetic disk is not more than 30 μm, the degradation in recording/reproducing properties caused by disk distortion can be prevented even when the magnetic disk cartridge is reduced in size and therefore the adhesion region and data recording region of the magnetic disk are located closer to each other.

FIG. 4 is a sectional view showing a region where a magnetic disk 5 and a center core 10 are affixed one another in a magnetic disk cartridge 1 of the present invention. The magnetic disk 5 in FIG. 4 has a structure in which a flexible disk-like base constituted by, for example, a polyester sheet has a magnetic layer formed on each side thereof.

The flatness of the magnetic disk measured along the radially outermost part OP of the region, which is affixed to the upper surface of the center core, of the magnetic disk 5 while making a full turn of the magnetic disk 5 is not more than 30 μm, preferably not more than 20 μm. The term “flatness” in this context means a difference between the maximum and minimum displacements of the surface of the magnetic disk 5. Measuring methods usable for this include measuring displacements of a magnetic disk 5 at a position of the radially outermost part OP in the region affixed to a center core 10 through the use of a ultra-precision laser displacement sensor (such as the LC-2430 sensor commercially available from Keyence Corporation) while rotating the magnetic disk 5 at 15 rpm rotational speed by means of a spindle having a flatness of 0.1 μm with the disk being chucked and held by the spindle.

It was found that when the flatness at a position of the radially outermost part OP in the adhesion region PR is controlled not to exceed 30 μm, the recording/reproducing properties and a followability to a servo track signal are kept reliable and stable for a large capacity magnetic disk 5 having a surface recording density of not less than about 158.7 Mbit/cm² (1 Gbit/inch²) as described above. Thus, it is considered that, for a magnetic disk 5 such as small as of 46.5 mm diameter as mentioned above, while the distance between the adhered region PR and the data recording area is short whereby the data recording area is susceptible to distortion of the adhered region, this tendency can be prevented by controlling the flatness at the position of the radially outermost part in the adhesion region of the magnetic disk not to exceed 30 μm as described above.

Possible approaches for controlling the flatness of the radially outermost part OP of the adhesion region PR not to exceed 30 μm as described above include: flattening a magnetic disk 5; flattening the upper surface 10a of a center core 10; and carrying out a flattening step during a process for manufacturing magnetic disk cartridges 1.

The approach for flattening a magnetic disk 5 may be controlling the flatness of a region corresponding to the position of the radially outermost part in the adhesion region PR not to exceed than 30 μm, preferably not more than 15 μm, by reducing the distortion of the magnetic disk 5 at a region affixed to a center core. Specific methods usable for this include: to store a magnetic disk 5 formed by blanking a flat magnetic sheet in a disk-like shape in a hot environmental temperature of, for example, not less than 50° C.; and to eliminate a curling imparted to a magnetic sheet during the manufacturing process by controlling the storage time of the magnetic sheet in a wound state in a roll form before blanking a magnetic disk 5. The term “flatness of the magnetic disk 5 itself” in this context means a difference between the maximum and minimum displacements when a displacement of the region corresponding to the position of the radially outermost part in the adhesion region PR of a magnetic disk 5 is measured by the ultra-precision laser displacement sensor LC-2430 commercially available from Keyence Corporation while rotating at 15 rpm a blanked magnetic disk 5 placed on a rotary stage.

This can reduce the distortion produced in the blanked magnetic disk 5, as a result of which the flatness of the magnetic disk 5 itself can be controlled not to exceed 30 μm, preferably not to exceed 15 μm. When the magnetic disk 5 after subjected to the aforementioned processing is affixed to the center core 10, the flatness of the outermost part OP in the adhesion region PR can be controlled not to exceed 30 μm, more preferably not to exceed 20 μm.

Further, the approach for flattening a magnetic disk 5 may be controlling the burrs along the edge of the punched portion of the radially inward area of the magnetic disk not to exceed 20 μm, thereby reducing burrs that might be produced when the radially inward area is punched. This can reduce the distortion caused by the burrs when a magnetic disk 5 is affixed to a center core 10, as a result of which the flatness of the radially outermost part OP in the adhesion region PR, to which the center core 10 is affixed, of the magnetic disk can be controlled not to exceed 30 μm, preferably not to exceed 20 μm.

Still further, the approach for flattening a magnetic disk 5 may be increasing the stiffness of the magnetic disk 5, thereby reducing its tendency to become wrinkled. Specific methods usable for this include controlling the annular stiffness of the magnetic disk 5 to not less than 2.0 g but not more than 16.0 g, thereby reducing the tendency of the magnetic disk 5 to become wrinkled. The term “annular stiffness” in this context means the reaction force of a loop sample. At this time, the loop sample is provided by cutting a magnetic sheet used for magnetic disks 5 into a rectangular strip about 12.7 mm wide by 70 mm long and then forming the so obtained strip into a loop form having a circumferential length of 5 cm. Then, the reaction force is measured while pressing a strain gate against the loop to the depth of about 5 mm. This can reduce the tendency of the magnetic disk 5 to become distorted, and accordingly the flatness of the radially outermost part OP in the adhesion region PR can be controlled not to exceed 30 μm, preferably not to exceed 20 μm.

Further, the approach for flattening the upper surface 10a of a center core 10 may be controlling the flatness of the upper surface 10a of the center core 10 not to exceed 20 μm. In this approach, the flatness is measured by the same procedure as that used in the foregoing method of measuring the flatness of the magnetic disk 5 itself. When the magnetic disk 5 after subjected to the aforementioned processing is affixed to the center core 10, the flatness of the radially outermost part OP in the adhesion region PR can be controlled not to exceed 30 μm, more preferably not to exceed 20 μm.

Further, one approach for carrying out a flattening step during a process for manufacturing magnetic disk cartridges 1 may be affixing a magnetic disk 5 to a center core 10 such that a surface of the magnetic disk 5 on the side opposite the direction in which the burrs are produced during blanking the magnetic disk 5 is affixed to the center core 10. This prevents production of distortion as a consequence of burrs, and accordingly the flatness of the radially outermost part OP in the adhesion region PR can be controlled not to exceed 30 μm, preferably not to exceed 20 μm.

Another approach for carrying out a flattening step during a process for manufacturing magnetic disk cartridges 1 may be eliminating the disk distortion, wherein the magnetic disk 5 is stored in a hot environment after the magnetic disk 5 and a center core are affixed to each other. The heat treatment conducted during this approach can reduce the distortion of the adhesive member 11 and magnetic disk 5, and consequently the flatness of the radially outermost part OP in the adhesion region PR can be controlled not to exceed 30 μm, preferably not to exceed 20 μm.

According to the foregoing embodiments, when the magnetic disk 5 has a surface recording density of about 158.7 Mbit/cm² and the adhesion region PR affixed on the upper surface 10a of the magnetic disk 5 has a flatness of not more than 30 μm, spacing variations between the magnetic disk 5 and a recording/reproducing head is reduced and therefore reliable stable recording properties (data signal, servo signal, etc.) are ensured, as a result of which a high density recording is achieved even for a small magnetic disk 5 which can be subjected to high-density recording.

In addition, if a flatness of the region, which is affixed to the center core 10, of the magnetic disk 5 is not more than 30 μm, degradation of the recording/reproducing properties caused by distortion of the adhesion region of the magnetic disk can be prevented even when the magnetic disk cartridge 1 is reduced in size and therefore the adhesion region and data recording region of the magnetic disk 5 are placed closer to each other.

Further, according to the magnetic disk cartridge of the present invention, an AMR head of the disk drive is used for reproducing the information on a magnetic disk 5 while rotating the magnetic disk at a rotary speed of not less than 3000 rpm. The information on the magnetic disk 5 is recorded at a high density such that a track recording density of not less than 100 Kbpi or a track density of not less than 10 Ktpi; and a surface recording density of about 158.7 Mbit/cm² (1 Gbit/inch²), preferably 5 Gbit/inch².

As the foregoing magnetic disk 5 available for high density recording, those having a structure in which a substantially nonmagnetic under layer containing a nonmagnetic powder and a binder and a magnetic layer containing ferromagnetic hexagonal ferrite powder and a binder, are formed on a flexible non-magnetic substrate in this order are suitable, but not limited thereto. The hexagonal ferrite includes a barium ferrite, a strontium ferrite, a lead ferrite, a calcium ferrite, and a substitution product thereof such as a cobalt substitution product. This enables achievement of low noise and a high S/N ratio even when the magnetic disk 4 is subjected to high-density recording.

The magnetic disk 5 is affixed to the upper surface 10a on the center core 10 such that the center CL of the magnetic disk 5 is centered on the rotation axis of the center core 10 via an acrylic adhesive or via an adhesive member 11 such as a double sided adhesive tape having a backing of polyethylene naphthalate (PET) or non-woven fabric.

TABLE 1

| | Average thickness of | | |
|---|---|---|---|
| | double sided adhesive | Wobbling value | Deviation |
| Sample | tape (μm) | (μm) | rate (%) |
| 1 | 10 | 11 | 3 |
| 2 | 30 | 12 | 3 |
| 3 | 48 | 12 | 3 |
| 4 | 80 | 14 | 4 |
| 5 | 125 | 16 | 5 |
| 6 | 160 | 18 | 6 |
| 7 | 205 | 34 | 23 |

What is claimed is:

1. A magnetic disk cartridge comprising: a flexible magnetic disk having a disk-like center core, the upper surface of the disk-like center core being centrally affixed to the magnetic disk; and a flat housing for rotatably holding therein the magnetic disk,
wherein the magnetic disk has a surface recording density of at least about 158.7 Mbit/cm², and
the disk wobbling value of the magnetic disk measured at a radial position located 5 mm outward from the outer diameter of the center core of the magnetic disk while rotating the magnetic disk by means of a drive device via the center core is not more than 20 μm.

2. The magnetic disk cartridge according to claim 1, wherein the magnetic disk is fixedly attached to the center core via a double sided adhesive tape.

3. The magnetic disk cartridge according to claim 2, wherein the double sided adhesive tape has an average thickness in the range of 10 μm to 160 μm.

4. The magnetic disk cartridge according to claim 2, deviation of the thickness of the double sided adhesive tape from its average thickness is within 10%.

5. The magnetic disk cartridge according to claim 2, wherein the double sided adhesive tape comprises a film backing having an adhesive layer on each side thereof.

6. The magnetic disk cartridge according to claim 5, wherein the film backing is formed of polyester.

7. The magnetic disk cartridge according to claim 5, wherein the double sided adhesive tape comprises a film backing having an adhesive layer on each side, and each adhesive layer has a thickness in the range from 4 μm to 40 μm.

8. The magnetic disk cartridge according to any one of claims 2, wherein the double-sided adhesive tape consists of a single adhesive layer.

9. The magnetic disk cartridge according to claim 1, wherein flatness of the magnetic disk surface when measured along the radially outermost peripheral edge of the region of the magnetic disk which is affixed to the disk-like center core is not more than 30 μm.

10. The magnetic disk cartridge according to claim 9, wherein the magnetic disk is fixedly attached to the center core via a double sided adhesive tape.

11. A magnetic disk cartridge according to claim 10, wherein the double sided adhesive tape has an average thickness in the range of 10 μm to 160 μm.

12. A magnetic disk cartridge according to claim 10, wherein deviation of the thickness of the double sided adhesive tape from its average thickness is within 10%.

13. The magnetic disk cartridge according to claim 6, wherein the polyester is polyethylene terephthalate or polyethylene naphthalate.

14. The magnetic disk cartridge according to claim 1, wherein the magnetic disk has a structure in which a substantially nonmagnetic base layer and a magnetic layer are formed on a non-magnetic carrier in this order, the magnetic layer being composed of ferromagnetic hexagonal ferrite powder and a binder.

15. A magnetic disk cartridge comprising: a flexible magnetic disk having a disk-like center core, the upper surface of the disk-like center core being centrally affixed to the magnetic disk; and a flat housing for rotatably holding therein the magnetic disk,
wherein the magnetic disk has a surface recording density of at least about 158.7 Mbit/cm², and the magnetic disk is fixedly attached to the center coa via a double sided adhesive layer on each side thereof.

16. The magnetic disk cartridge of claim 15, wherein said double sided adhesive tape has a total average thickness ranging from 10 to 35 μm.
